(19) United States
(12) Patent Application Publication
(10) Pub. No.: US 2025/0029778 A1
(43) Pub. Date: Jan. 23, 2025

(54) POWER MODULE COMPONENT, MANUFACTURING METHOD THEREFOR AND APPLICATION THEREOF

(71) Applicants: HUIZHOU POCO NEW INDUCTOR TECHNOLOGY CO., LTD., Guangdong (CN); SHENZHEN POCO MAGNETIC CO., LTD., Shenzhen (CN); HUIZHOU POCO INDUSTRY CO., LTD., Huizhou (CN); HEYUAN POCO NEW MAGNETIC CO., LTD., Heyuan (CN)

(72) Inventors: Zhihang Jiang, Shenzhen (CN); Shaofei Wang, Shenzhen (CN); Xiongzhi Guo, Shenzhen (CN)

(73) Assignees: HUIZHOU POCO NEW INDUCTOR TECHNOLOGY CO., LTD., Guangdong (CN); SHENZHEN POCO MAGNETIC CO., LTD., Shenzhen (CN); HUIZHOU POCO INDUSTRY CO., LTD., Huizhou (CN); HEYUAN POCO NEW MAGNETIC CO., LTD., Heyuan (CN)

(21) Appl. No.: 18/400,072

(22) Filed: Dec. 29, 2023

(30) Foreign Application Priority Data
Jul. 18, 2023 (CN) 202310878387.X

(51) Int. Cl. H01F 27/38; H01F 27/30

(52) U.S. Cl. CPC H01F 27/38; H01F 27/306

(57) ABSTRACT

Disclosed are a power module component, a manufacturing method therefor and an application thereof, and the manufacturing method comprises: forming an inductor collection; and cutting the inductor collection to obtain the power module component, where the power module component comprises a plurality of windings which are arranged at intervals along a first direction in sequence. In the present application, a plurality of windings are designed to be arranged at intervals along the same direction on a conductor, and then separated into a plurality of power module components by cutting, thereby reducing the fluidity requirement for magnetic powder, overcoming the difficulty in implanting windings into the mold cavity, and reducing the DC resistance of the inductor.

### CROSS-REFERENCE TO RELATED APPLICATION(S)

This application claims priority to Chinese Patent Application No. 202310878387. X filed Jul. 18, 2023, the disclosure of which is incorporated herein by reference in its entirety.

### TECHNICAL FIELD

The present application belongs to the technical field of magnetic component manufacturing, and relates to a power module component, a manufacturing method therefor and an application thereof.

### BACKGROUND

The inductor is increasingly important in the development of high power-density power supplies. The inductor accounts for a large proportion in the size, weight and loss in high power-density power supplies. Magnetic integration is a main method to reduce the size of the inductor. Compared with the conventional inductor, it has higher inductance and smaller leakage inductance.

The integral-molding inductor has the advantages of small volume, small DC resistance and large output current. The number of turns in the coil is small, the DC resistance is small, large current can be beared, the energy storage is high, and the integral-molding inductor has saturation resistance, and higher output current value than the conventional inductor. Because the inductor has an “integrated” structure and molded with magnetic material totally, the heat transfer is quick, the heat dissipation area is large and the coil has good heat dissipation

CN103635979A provides an integrated inductor, which comprises a multi-winding inductor having a transformer winding (L1) and a resonant inductor (L2). Portions (1) and (2) of a magnetic circuit of the transformer winding (L1) are integrated into a magnetic circuit of at least two portions (L2A) and (L2B) of the resonant inductor (L2) so as to form a common portion of the magnetic circuits of the multi-winding inductor (L1) and the resonant inductor (L2) having at least two portions (L2A) and (L2B), wherein the transformer winding (L1) of the multi-winding inductor is wound around a column (11), the column (11) has at least one air gap (G), and a width of the air gap (G) is adjusted, so that the magnetic inductance generated by the resonant inductor (L2) having at least two portions (L2A) and (L2B) is less than 25% of the magnetic inductance generated by the transformer winding (L1) of the multi-winding inductor.

CN114496531A provides an integrated inductor and a power module. The integrated inductor comprises a magnetic core and two windings, the magnetic core comprises two winding columns, a first cover plate arranged at the bottom of the two winding columns, a second cover plate arranged at the top of the two winding columns and opposite to the first cover plate, and a common column or a side column, the two winding columns are arranged in parallel, an air gap is arranged on each winding column, the common column or the side column is connected between the first cover plate and the second cover plate, and the two windings are respectively wound on the two winding columns, wherein a direct current component or a frequency current component of current flowing through each of the two windings surrounds the winding columns in the same direction, and the phase difference of the high-frequency current components of the current flowing through each of the two windings is 180 degrees, and a coupling coefficient between the two windings is less than 0.1.

However, because a plurality of inductors are integrated into one magnet for the small integrated inductor, and the terminals are required to be at the bottom of the inductor, if the high-pressure integral-molding method is used, the challenges for implanting windings into the mold cavity and subsequent processing are huge, and the fluidity requirement for the powder is high, and other processes of electroplating/silvering increase the DCR of the product by several times to more than ten times.

Therefore, it is urgent to improve the manufacturing process of small integrated inductors while ensuring that the DCR does not increase and to overcome the difficulty in implanting windings into the mold cavity.

### SUMMARY

In view of the shortcomings in the prior art, the present application provides a power module component, a manufacturing method therefor and an application thereof. In the present application, a plurality of windings are designed to be arranged at intervals along the same direction on a conductor, and then separated into a plurality of power module components by cutting, thereby reducing the fluidity requirement for the magnetic powder, overcoming the difficulty in implanting windings into the mold cavity, and reducing the DC resistance of the inductor.

To achieve the object, the present application adopts the following technical solutions.

In a first aspect, the present application provides a manufacturing method for a power module component, and the manufacturing method comprises:
forming an inductor collection, where the inductance collection comprises a plurality of windings arranged in an array; and
cutting the inductor collection to obtain the power module component, where the power module component comprises a plurality of windings which are arranged at intervals along a first direction in sequence.

In the present application, a plurality of windings are designed to be arranged at intervals along the same direction on a conductor, and then separated into a plurality of power module components by cutting, thereby reducing the fluidity requirement for the magnetic powder, overcoming the difficulty in implanting windings into the mold cavity, and reducing the DC resistance of the inductor.

The inductor collection in the present application is an collection composed of a plurality of the power module components.

Those skilled in the field should know that “a plurality of” refers to at least two, which can be, for example, three, five, six, eight or ten.

Preferably, the step of forming the inductor collection comprises:
forming a first magnetic powder layer at the bottom of a mold:
forming a winding layer on the first magnetic powder layer:
forming a second magnetic powder layer on the winding layer; and
pressing the above layers to obtain the inductor collection.

Preferably, the winding layer comprises a plurality of windings arranged in an array, and the windings along the first direction are arranged at intervals in sequence, the windings along a second direction are connected in sequence, and the first direction and the second direction are perpendicular.

In the present application, a plurality of windings are designed to be arranged in an array on a conductor, and then separated into a plurality of power module components by cutting, thereby enlarging the molding size, facilitating the implantation of the windings, reducing the fluidity requirements for the magnetic powder, overcoming the difficulty in implanting windings into the mold cavity, and reducing the DC resistance of the inductor.

Preferably, the pressing is performed at a pressure of 10-20 T/cm², which can be, for example, 10 T/cm², 12 T/cm², 15 T/cm², 18 T/cm² or 20 T/cm²; however, the pressure is not limited to the listed values, and other unlisted values within the numerical range are also applicable.

Preferably, the pressing is performed for a period of holding pressure of 1.5-5 s, which can be, for example, 1.5 s, 2 s, 3 s, 4 s or 5 s; however, the period of holding pressure is not limited to the listed values, and other unlisted values within the numerical range are also applicable.

Preferably, before the step of cutting the inductor collection, the manufacturing method further comprises: grinding the inductor collection to expose terminals of the windings.

In the present application, the grinding is performed with a grinding machine, which has a more reliable manner of fixing for grinding. When the small and thin product is fixed by a magnetic chuck, the contact area of the product is small, the corresponding suction strength is also small, and the product is easy to be knocked off during the grinding: for the combination molding, the contact area of the product is increased, and the suction strength is also increased, and the product is easy to be fixed. For example, in a case where the size of the product is 5×1.5×1 mm (length×width×height), and the grinding is performed against the height direction, which has a contact area of 5×1.5: when the molding is performed in a combined manner, the area can be enlarged, for example, which can be expanded to 5×3/5×4.5/5×6 . . . , and the width direction can be enlarged in integer multiples.

Because the size of the inductor collection is at least twice as large as the size of the power module component, the size requiring the grinding is increased, and the difficulty of the grinding is reduced.

Preferably, before the step of cutting the inductor collection, the manufacturing method further comprises: forming a plurality of first cutting positioning grooves on a first surface of the inductor collection; and
forming a plurality of second cutting positioning grooves on a second surface which is opposite to the first surface of the inductor collection, and each of the first cutting positioning grooves is correspondingly arranged with one of the second cutting positioning grooves.

Preferably, the inductor collection is cut along a direction from one of the first cutting positioning grooves to one of the second cutting positioning grooves which is corresponding to the first cutting positioning groove.

In a second aspect, the present application provides a power module component, and the power module component is manufactured by adopting the manufacturing method according to the first aspect.

Preferably, the power module component is molded integrally.

Preferably, the power module component has a DC resistance of 0.1-0.5 mΩ, which can be, for example, 0.1 mΩ, 0.2 mΩ, 0.3 mΩ, 0.4 mΩ or 0.5 mΩ; however, the DC resistance is not limited to the listed values, and other unlisted values within the numerical range are also applicable.

The power module component is an integral-molding integrated inductor, which has even inductance distribution, smaller volume and higher integration level, reduces the cost of the system, and improves the efficiency and reliability of the system simultaneously.

In view of the above technical solutions, the beneficial effects of the present application are as follows.

In the present application, a plurality of windings are designed to be arranged at intervals along the same direction on a conductor, and then separated into a plurality of power module components by cutting, thereby reducing the fluidity requirements for the magnetic powder, overcoming the difficulty in implanting windings into the mold cavity, and reducing the DC resistance of the inductor.

### BRIEF DESCRIPTION OF DRAWINGS

FIG. 1 is a schematic flow diagram of a manufacturing method for a power module component provided in examples of the present application.

FIG. 2 is a schematic sub-flow diagram of a manufacturing method for a power module component provided in examples of the present application.

FIG. 3 is a schematic diagram showing a structure after the pressing in the manufacturing method in Example 1.

FIG. 4 is a schematic diagram showing a structure after the grinding in the manufacturing method in Example 1.

FIG. 5 is a schematic diagram showing a structure after the cutting in the manufacturing method in Example 1.

FIG. 6 is a structural schematic diagram of the power module component in Example 1.

FIG. 7 is a structural schematic diagram of the power module component in Comparative Example 1.

FIG. 8 is a structural schematic diagram of the power module component in Comparative Example 2.

FIG. 9 is a schematic diagram showing the grinding in Comparative Example 3.

Reference list: 1—winding, 2—magnet, 3—1—first cutting positioning groove, 3—2—second cutting positioning groove, 4—terminal, 10—first power module component, 20—second power module component, 30—third power module component, 40—power module component.

### DETAILED DESCRIPTION

According to an aspect of the present application, a manufacturing method for a power module component is provided, referring to FIG. 1. FIG. 1 is a schematic flow diagram of a manufacturing method for a power module component provided in examples of the present application, and as shown in FIG. 1, the manufacturing method comprises:
step 101, an inductor collection is formed, where the inductance collection comprises a plurality of windings arranged in an array; and
step 102, the inductor collection is cut to obtain the power module component, where the power module component comprises a plurality of windings which are arranged at intervals along a first direction in sequence.

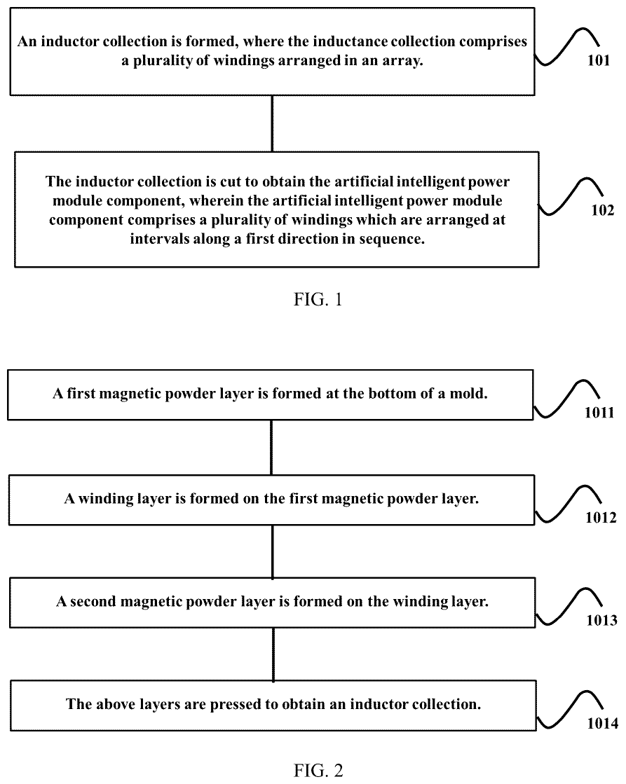

FIG. 2 is a schematic sub-flow diagram of a manufacturing method for a power module component provided in examples of the present application, and as shown in FIG. 2, the step 101 comprises:
step 1011, a first magnetic powder layer is formed at the bottom of a mold;
step 1012, a winding layer is formed on the first magnetic powder layer:
step 1013, a second magnetic powder layer is formed on the winding layer; and
step 1014, the above layers are pressed to obtain the inductor collection.

In one example, the winding layer comprises a plurality of windings arranged in an array, and the windings along the first direction are arranged at intervals in sequence, the windings along a second direction are connected in sequence, and the first direction and the second direction are perpendicular.

In one example, the pressing is performed at a pressure of 10-20 T/cm².

In one example, the pressing is performed for a period of holding pressure of 1.5-5 s.

In one example, before the step of cutting the inductor collection, the manufacturing method further comprises: the inductor collection is ground to expose terminals of the windings.

In one example, before the step of cutting the inductor collection, the manufacturing method further comprises:
a plurality of first cutting positioning grooves are formed on a first surface of the inductor collection; and
a plurality of second cutting positioning grooves are formed on a second surface which is opposite to the first surface of the inductor collection, and each of the first cutting positioning grooves is correspondingly arranged with one of the second cutting positioning grooves.

In one example, the inductor collection is cut along a direction from one of the first cutting positioning grooves to one of the second cutting positioning grooves which is corresponding to the first cutting positioning groove.

According to another aspect of the present application, a power module component is provided, and the power module component is manufactured by adopting the manufacturing method.

In one example, the power module component is molded integrally.

In one example, the power module component has a DC resistance of 0.1-0.5 mΩ.

The technical solutions of the present application are further illustrated below via specific embodiments in conjunction with accompanying drawings. However, the following examples are only simple examples of the present application and do not represent or limit the protection scope of claims of the present application, and the protection scope of the present application shall be defined by the claims.

### Example 1

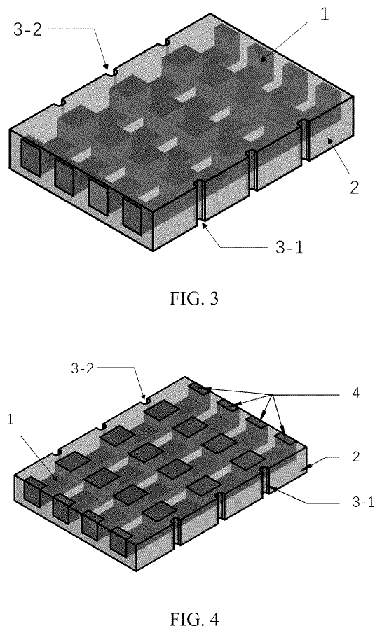

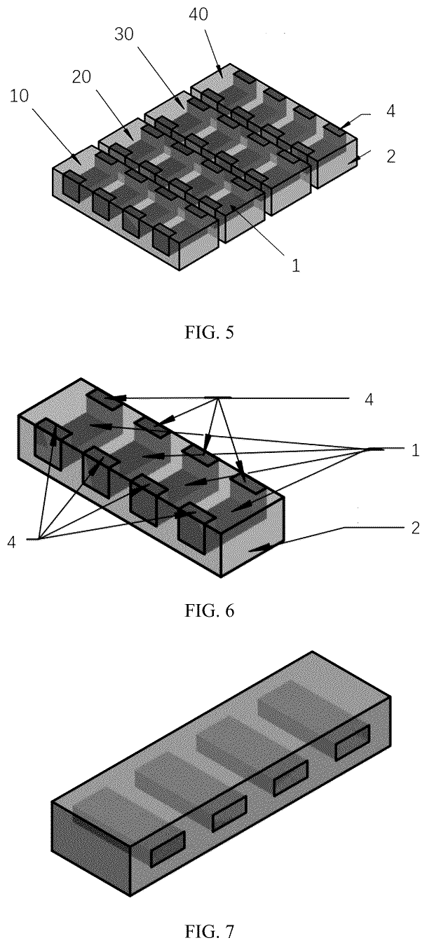

This example provides a manufacturing method for a power module component, and the manufacturing method comprises the following steps:
a first magnetic powder layer was formed at the bottom of a mold, a winding layer was formed on the first magnetic powder layer, and a second magnetic powder layer was formed on the winding layer: and the above layers were pressed with a pressure of 10-20 T/cm² for 1.5-5 s to form an inductor collection, and the inductor collection is shown in FIG. 3:
the inductor collection was ground to expose terminals 4 of the windings 1, and the schematic diagram of a structure after grinding is shown in FIG. 4: a plurality of first cutting positioning grooves 3-1 were formed on a first surface of a magnet 2 of the inductor collection: a plurality of second cutting positioning grooves 3-2 were formed on a second surface of the magnet 2 which was disposed opposite to the first surface of the magnet 2 of the inductor collection, and each of the first cutting positioning grooves 3-1 was correspondingly arranged with one of the second cutting positioning grooves 3-2; and
the inductor collection was cut, wherein a cutting direction was a direction from one of the first cutting positioning grooves 3-1 to one of the second cutting positioning grooves 3-2 which was corresponding to the first cutting positioning groove 3-1, and the schematic diagram of a structure after cutting is shown in FIG. 5: and four power module components were obtained, namely, a first power module component 10, a second power module component 20, a third power module component 30 and a fourth power module component 40, and as shown in FIG. 6, the power module component comprised a plurality of windings 1 arranged at intervals along a first direction in sequence.

The manufacturing method overcomes the difficulty in implanting windings into the mold cavity, overcomes the difficulty in grinding small integrated inductors and reduces the fluidity requirement for the magnetic powder.

The power module component has a DC resistance of 0.15 mΩ.

### Comparative Example 1

This comparative example provides a power module component and a manufacturing method therefor. The difference between this comparative example and Example 1 is that the terminals were introduced into a side of the magnet by silvering or electroplating, as shown in FIG. 7.

The power module component has a DC resistance of 1-3 mΩ.

### Comparative Example 2

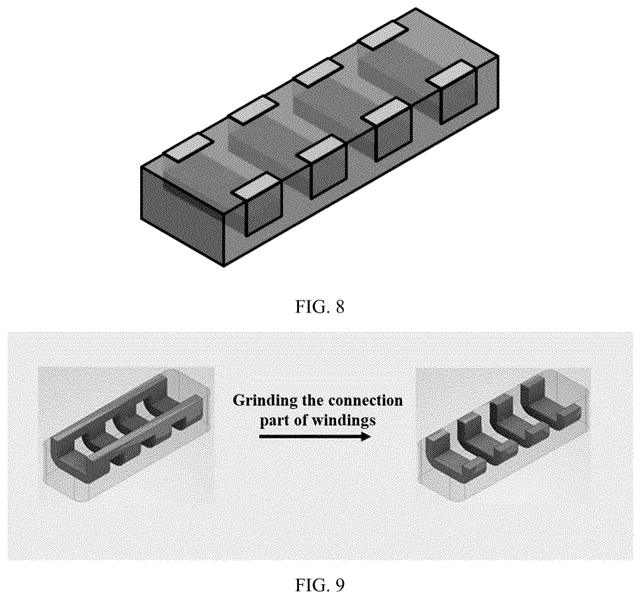

This comparative example provides a power module component and a manufacturing method therefor. The difference between this comparative example and Example 1 is that the terminals were introduced into a bottom of the magnet by silvering or electroplating, as shown in FIG. 8.

The power module component has a DC resistance of 1-3 mΩ.

### Comparative Example 3

This comparative example provides a manufacturing method for a power module component, and the manufacturing method comprises the following steps:
(1) a magnetic powder was embedded in windings to obtain an inductor unit:
(2) the inductor unit was ground, as shown in FIG. 9, and a connection part of the windings and the magnetic powder on the surface were removed away by grinding, and the terminals should be leveled; and
(3) the ground inductor unit was subjected to pressing and integral-molding to obtain the power module component.

The power module component has a DC resistance of 1-3 mΩ. The windings of the power module component is difficult to be implanted into the mold cavity and ground, because when the mold cavity is small, the fluidity requirement for the magnetic powder material is high.

As can be seen, in the present application, a plurality of windings are designed to be arranged at intervals along the same direction on a conductor, and then separated into a plurality of power module components by cutting, thereby reducing the fluidity requirement for the magnetic powder, overcoming the difficulty in implanting windings into the mold cavity, and reducing the DC resistance of the inductor.

The inductance distribution of the power module components obtained in Example 1 (Table 1) and Comparative Example 2 (Table 2) is tested, and the results are shown in the tables.

TABLE 1

| | | Winding 1 | Winding 2 | Winding 3 | Winding 4 |
|---|---|---|---|---|---|
| Integrated inductor No. | | (L1) | (L2) | (L3) | (L4) |
| 1^{#} | Initial inductance | 12.06 | 12.05 | 12.28 | 12.37 |
| | Saturation inductance (15A) | 8.73 | 8.46 | 7.98 | 7.9 |
| 2^{#} | Initial inductance | 12.92 | 13.03 | 12.8 | 12.04 |
| | Saturation inductance (15A) | 9.63 | 9.75 | 8.92 | 8.86 |
| 3^{#} | Initial inductance | 12.85 | 12.7 | 13.41 | 12.23 |
| | Saturation inductance (15A) | 9.46 | 8.59 | 10.33 | 8.61 |
| 4^{#} | Initial inductance | 11.02 | 11.68 | 12.02 | 11.75 |
| | Saturation inductance (15A) | 8.45 | 8.81 | 9.2 | 9.25 |
| 5^{#} | Initial inductance | 11.89 | 11.22 | 11.97 | 11.27 |
| | Saturation inductance (15A) | 8.66 | 7.67 | 8.89 | 8.43 |

TABLE 2

| | | Winding 1 | Winding 2 | Winding 3 | Winding 4 |
|---|---|---|---|---|---|
| No. | | (L1) | (L2) | (L3) | (L4) |
| 1^{#} | Initial inductance | 11.38 | 13.82 | 13.51 | 11.38 |
| | Saturation inductance (15A) | 7.43 | 8.85 | 8.84 | 7.45 |
| 2^{#} | Initial inductance | 11.33 | 16.3 | 16.31 | 13.63 |
| | Saturation inductance (15A) | 7.3 | 10.29 | 10.68 | 9.77 |
| 3^{#} | Initial inductance | 11.33 | 15.97 | 14.92 | 12.1 |
| | Saturation inductance (15A) | 7.77 | 9.21 | 8.83 | 7.51 |
| 4^{#} | Initial inductance | 10.99 | 13.19 | 13.19 | 12.02 |
| | Saturation inductance (15A) | 7.89 | 9.18 | 9.31 | 8.43 |
| 5^{#} | Initial inductance | 11.26 | 12.47 | 12.29 | 10.87 |
| | Saturation inductance (15A) | 7.38 | 7.98 | 7.93 | 7.78 |

It can be seen from the above tables that the power module component in the present application is an integral-molding integrated inductor with uniform inductance distribution, smaller volume and higher integration level, which can reduce the cost of the system and improve the efficiency and reliability of the system.

The above examples of the present application are used to illustrate detailed structural features of the present application, but the present application is not limited to the above detailed structural features, that is, the present application does not necessarily rely on the above detailed structural features to be implemented. Those skilled in the field should understand that any improvement of the present application, the equivalent substitution of selected components, the addition of auxiliary components, and the selection of specific methods in the present application shall fall within the protection scope and disclosure scope of the present application.

What is claimed is:

1. A manufacturing method for a power module component, comprising:
forming an inductor collection, wherein the inductance collection comprises a plurality of windings arranged in an array: and
cutting the inductor collection to obtain the power module component, wherein the power module component comprises a plurality of windings which are arranged at intervals along a first direction in sequence.

2. The manufacturing method for a power module component according to claim 1, wherein the step of forming the inductor collection comprises:
forming a first magnetic powder layer at the bottom of a mold;
forming a winding layer on the first magnetic powder layer:
forming a second magnetic powder layer on the winding layer; and
pressing the above layers to obtain the inductor collection.

3. The manufacturing method for a power module component according to claim 2, wherein the winding layer comprises a plurality of windings arranged in an array, and the windings along the first direction are arranged at intervals in sequence, the windings along a second direction are connected in sequence, and the first direction and the second direction are perpendicular.

4. The manufacturing method for a power module component according to claim 2, wherein the pressing is performed at a pressure of 10-20 T/cm².

5. The manufacturing method for a power module component according to claim 2, wherein the pressing is performed for a period of holding pressure of 1.5-5 s.

6. The manufacturing method for a power module component according to claim 1, wherein before the step of cutting the inductor collection, the manufacturing method further comprises:
grinding the inductor collection to expose terminals of the windings.

7. The manufacturing method for a power module component according to claim 1, wherein before the step of cutting the inductor collection, the manufacturing method further comprises:
forming a plurality of first cutting positioning grooves on a first surface of the inductor collection; and
forming a plurality of second cutting positioning grooves on a second surface which is opposite to the first surface of the inductor collection, and each of the first cutting positioning grooves is correspondingly arranged with one of the second cutting positioning grooves.

8. The manufacturing method for a power module component according to claim 7, wherein the inductor collection is cut along a direction from one of the first cutting positioning grooves to one of the second cutting positioning grooves which is corresponding to the first cutting positioning groove.

9. A power module component, which is manufactured by adopting the manufacturing method for a power module component according to claim 1.

10. The power module component according to claim 9, wherein the power module component is molded integrally;
the power module component has a DC resistance of 0.1-0.5 mΩ.
